(19) United States
(12) Patent Application Publication
(10) Pub. No.: US 2006/0126641 A1
(43) Pub. Date: Jun. 15, 2006

(54) Mapping system of virtual concatenation group signals

(76) Inventors: Joobin Song, Los Angeles, CA (US); Jong Ho Kim, Los Angeles, CA (US)

Correspondence Address: Andrew Kim, Suite 1050, 2 North Lake Avenue, Pasadena, CA, 91101, US

(21) Appl. No.: 11/301,377

(22) Filed: Dec. 13, 2005

Related U.S. Application Data
(60) Provisional application No. 60/636,702, filed on Dec. 15, 2004.

(51) Int. Cl. H04L 12/56

(52) U.S. Cl. 370/395.51; 370/465

(57) ABSTRACT

An interface system is capable of transmitting packet data or non-continuous data through a network that is adapted to transmit continuous data. In particular, the interface system is directed to transmitting data from Ethernet, Storage Area Network (SAN), and/or Digital Video Broadcasting (DVB) signals through a SONET fiber optics system. The interface system uses a Virtual Concatenation Group (VCG) signal to match the transmitting signal's bandwidth and effectively map it on to SONET/SDH frame. The interface system applies VCG mapping related to low order virtual container signals, VC-11 and VC-12 and higher order virtual container signals, VC-3 and VC-4. Likewise, the interface system may allow packet data to be transmitted through SDH configured network. The interface system may also use DPRAM (dual-port RAM) as the basic element of VCG mapping for the physical embodiment of VCG to reduce the size of the circuit. The interface system may also use two or more memories to prevent read/write collision that may occur when the input and output addresses are the same.

### RELATED APPLICATION

This application claims priority to a U.S. provisional application No. 60/636,702, filed Dec. 15, 2004, which is hereby incorporated by reference.

### FIELD OF THE INVENTION

This invention relates to an interfacing system capable of multiplexing virtual concatenation signals into STM-1 signals by using a mapping table and one or more memories.

### BACKGROUND OF THE INVENTION

Computer networking allows computers to share data. In general, there are two types of computer networking. The first type is a local area network (LAN) that connects many computers or devices which are relatively close to each other, usually in the same building. The second type is a wide area network (WAN) that connects a smaller number of computers or devices that are further apart from each other. Business or enterprise operators typically use Ethernet as their LAN. Carriers, on the other hand, typically deploy Synchronous Optical Network (SONET) that is synonymous with Synchronous Digital Hierarchy (SDH) as their WAN. SONET is a standard for optical telecommunications transport formulated by the Exchange Carriers Standards Association (ECSA) for the American National Standards Institute (ANSI), which sets industry standards in the U.S. for telecommunications and other industries. SONET is a comprehensive standard that is expected to provide the transport infrastructure for worldwide telecommunications for at least the next two or three decades. SDH is a set of international standards for broadband telecommunications over single mode fiber optic transmission systems, which were originally developed in the US as SONET.

When carriers provide network services to their enterprise customers, there is a mismatch between the services that the carriers can provide and the service the enterprise customers need. One of the reasons is that carriers have invested billions of dollars in SONET/SDH equipment, while enterprise operators have invested billions of dollars in Ethernet equipment, but the data from Ethernet cannot be directly transmitted through SONET/SDH. Data cannot be directly exchanged between Ethernet and SONET/SDH because SONET is designed to transmit continuous signals such as multiplexing voice signals, whereas Ethernet is designed to transmit non-continuous packet signals. The packet signals transmitted through Ethernet have burst characteristics where the size of the data or packet signals is different or non-continuous so that a variety of bandwidths are needed. In contrast, SONET is designed to transmit continuous signals so that the signals can be transmitted at a constant speed. Until recently, the enterprise customers and the carriers had few options to resolve the conflict. Enterprise customers either had to live with a less-than-optimal solution, or the carrier had to upgrade their network. Recent activity by the standard setting bodies, equipment manufacturers, and IC vendors have resolved the disconnect between Ethernet and SONET/SDH.

The solution to the enterprise-carrier gap is a set of protocols that allow the Enterprise customer to retain the simplicity of Ethernet, while allowing the carrier to leverage the billions of dollars invested in SONET. To allow Ethernet and SONET to work together, an interface system has been developed to allow non-continuous packet signals from Ethernet to pass though the existing SONET system which is designed to transmit continuous signals. The interface system includes Virtual Concatenation (VCAT), the Generic Framing Procedure (GFP) protocols, and Link Capacity Adjustment Scheme (LCAS) to allow carriers to use the existing SONET system to offer data services to their enterprise customers that are flexible, efficient and able to support not only Ethernet but also a multitude of data services such as FICON, DVB or Fiber Channel (FC).

VCAT is used to split up the bandwidth of SONET into right-size groups to use the bandwidth more efficiently. This allows SONET to have variable bandwidth to accommodate the non-continuous packet signal from Ethernet having different size data. In other words, VCAT breaks the bandwidth into smaller individual groups so that a right-sized bandwidth can be assigned to a packet signal from Ethernet depending on its size. VCAT works across the existing SONET to increase SONET utilization by effectively spreading the load across the whole network.

LCAS is a technology that can be used for further enhancement of VCAT performance, and it can be viewed as a supplementary technology that allows the adjustment of capacity in real time without the loss of data. In particular, LCAS increases or decreases the bandwidth of SONET dynamically depending on the size of the data. LCAS is a two-way handshake signaling protocol where adjustments to the capacity of the transmitter (So) and the receiver (Sk) is achieved by a control packet sequence of H4 Path overhead bytes for High Order(HO)-VCAT or K4 Path overhead bytes for Low Order(LO)-VCAT. The control packet consists of fields dedicated to a specific function and the information is bi-directional (from So to Sk and from Sk to So). Each control packet describes the state of the link during the next control packet; and the changes are sent in advance in order for the receiver to switch to the new configuration as soon as possible.

GFP enables Ethernet to send its data through SONET. GFP utilizes continuous signal and is developed to encapsulate Ethernet signal so that it can be mapped with a specific bandwidth so that it can be transmitted through SONET system.

Depending on the enterprises' need, the bandwidth of SONET is divided into right-size groups with the units of 1.5M, 2M, 45M or 150M. Each group is referred to as virtual concatenation group (VCG). In order to make VCG signal, technology which can segment GFP signal into the number of its components prior to the transmission and reassemble them again into GFP signal is required. FIG. 1 shows a prior art circuit diagram illustrating the basic principle of allocating a total of eight VCGs to each timeslot within one STM-1 signal frame. FIG. 1 shows eight Ethernet connections 104 and each Ethernet connection runs through its corresponding GFP block 106 in order to make the burst Ethernet signal into a continuous signal. When there is no signal from the Ethernet connection, the corresponding GFP block sends out a self defined IDLE frame as an output so that the last output from the corresponding GFP block is always a continuous data. In order to allocate transmitted data from a total of eight GFP blocks 106 to each VC-11 timeslot within STM-1, byte de-interleaver 110 is used to byte de-interleave GFP output signals to make each VC-11 signals 108. Here, the number and the position of VC-11 used by each VCG must be pre-designated. In order to multiplex output signal which has gone through byte de-interleaver 110 on each time slot on the STM-1 signal 102, a switching block 112 is used to control the connection between byte de-interleaver output signal 110 and STM-1 time slot 102. The input and output signals are equivalent to 84 VC-11 signal and the output is multiplexed through 84:1 byte interleaver. It becomes STM-1 signal by adding a few overhead bytes. As such, byte de-interleaver 110, switching block 112, and byte interleaver 114 are used to establish STM-1 signal from several GFP blocks. With the switching block 112, however, the size of the circuits of the byte interleaver and de-interleaver are large and especially since the switching block takes the 84:84 structure it becomes difficult to multiplex the actual circuit and the process becomes cumbersome. As such, there is a need to reduce the size of the circuitry and provide a more efficient system to interface Ethernet to SONET network system.

### INVENTION SUMMARY

This invention provides an interface system that is capable of transmitting packet data or non-continuous data through a network that is adapted to transmit continuous data. In particular, the invention is directed to transmitting data from Ethernet, Storage Area Network (SAN), and/or Digital Video Broadcasting (DVB) signals through a SONET fiber optics system. The interface system uses a Virtual Concatenation Group (VCG) signal to match the transmitting signal's bandwidth and effectively map it on to SONET/SDH frame. The interface system applies VCG mapping related to low order virtual container signals, VC-11 and VC-12 and higher order virtual container signals, VC-3 and VC-4. Likewise, the interface system may allow packet data to be transmitted through SDH configured network. The interface system may also use DPRAM (dual-port RAM) as the basic element of VCG mapping for the physical embodiment of VCG to reduce the size of the circuit. The interface system may also use two or more memories to prevent read/write collision that may occur when the input and output addresses are the same.

When mapping the output signal, the interface system may use a mapping table corresponding to a time slot, VCG, and SQ numbers. The interface system may use a two-stage mapping table in order to prevent the instability. For instance, a first stage mapping table can be changed without affecting the stored mapping information in the second stage mapping table. The stored mapping information in the first stage mapping table may be transferred to the second stage mapping table at the mapping table update time. This way, the stored mapping information in the second stage mapping table may be available for stability. The interface system may also use multi-signal producing blocks to make a GFP signal call and one step STM-N 1 level signal, without a separate multiplexing circuit. By using the interfacing system, the existing multiplexing element and demultiplexing elements are not needed, thereby reducing the size of the supply circuit.

Other systems, methods, features and advantages of the invention will be or will become apparent to one with skill in the art upon examination of the following figures and detailed description. It is intended that all such additional systems, methods, features and advantages be included within the description, be within the scope of the invention, and be protected by the accompanying claims.

### BRIEF DESCRIPTION OF THE DRAWINGS

FIG. 1 is a block diagram representing traditional mapping method of VCG signals on the STM-1 signal frame;

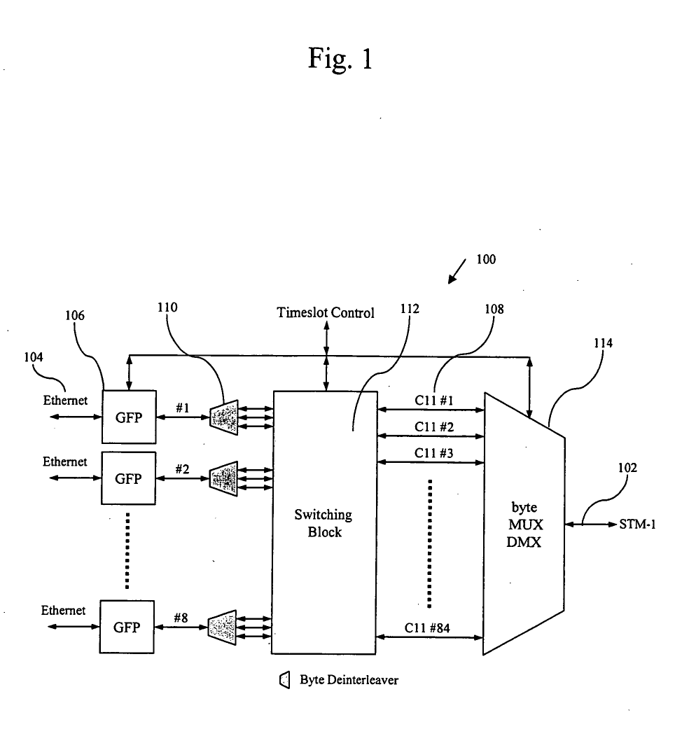

FIG. 2 is a block diagram for mapping VCG signals onto the STM-1 signal frame with dual-port memory;

FIG. 3 is a block diagram of the structure in VCG mapper using 2 memory elements and the mapping table;

FIG. 4 is a simplified diagram of the number of VC-11 time slots on the STM-1 frame;

FIG. 5 is an example of the mapping table;

FIG. 6 is a timing diagram of the mapping table shown in FIG. 5;

FIG. 7 is a block diagram of the interface signals to and from VCG mapper;

FIG. 8 is a block diagram of detailed structure of the VCG mapper; and

FIG. 9 is a timing diagram of the VCG mapper.

FIG. 10 is a flow chart illustrating a VCG mapper.

FIG. 11 is a flow chart illustrating subroutine for making control signals with VCG configuration.

FIG. 12 is a flow chart illustrating subroutine for writing and reading to and from a dual port memory.

### DETAILED DESCRIPTION OF THE INVENTION

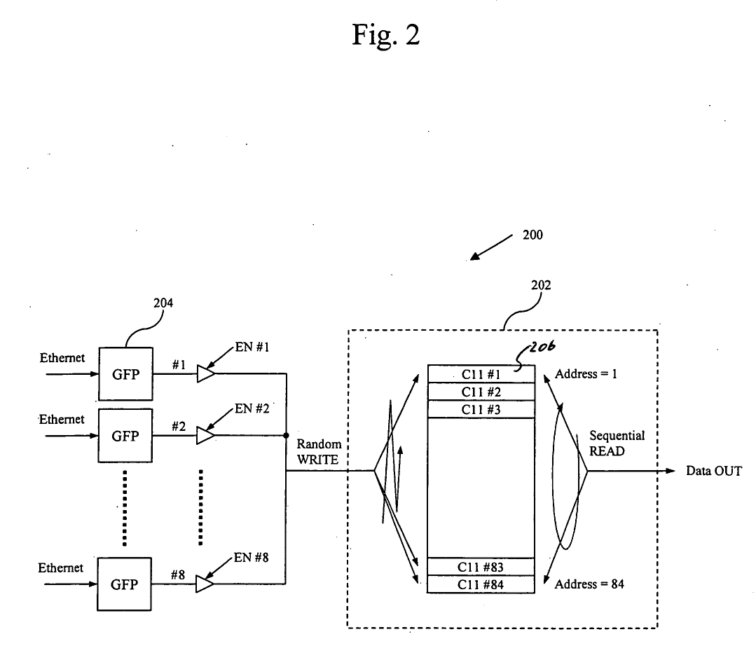

The interface system in accordance with this invention utilizes a memory 206 and a mapping port controlling the memory 206 to allow data in the form of packet signal to be transmitted over a network adapted to transmit continuous data. The memory 206 may be a dual port memory that is controlled by the mapping port to allow data from Ethernet to transmit over SONET. The interface system utilizes one or more memories to eliminate the need for byte interleaver, de-interlever or complex switching block, and the problems associated with these devices as discussed above. FIG. 2 shows an interfacing system diagram 200 utilizing a VCG mapper 202 configured to match the transmitting signal's bandwidth and effectively map the transmitting signal on to SONET/SDH frame. In this example, the VCG mapper 202 may include a memory 206 to perform the byte-unit signal execution. The memory 206 may have 84 VC-11 time slots where its width is 8-bit memory. As such, the address signal for the memory 206 is same as 84 VC-11 signal numbers for a STM-1 signal. Each VC-11 time slot is allocated to a corresponding GFP block 204. In this example, slight GFP blocks may be used. Each GFP block signal may have a valid value at a predetermined VC-11 time slot position to fit each bandwidth. Put differently, each VC-11 time slot for a STM-1 frame signal is not allocated to more than one GFP block so that all of the GFP block signals can be combined to complete the STM-1 frame signal if all of the control signal, denoted as enabler EN #1˜EN #8 in FIG. 2, are used. This allows all of the GFP block signals to have their respective VC-11 time slot within the memory 206, which correspond to the STM-1 frame signal requirement.

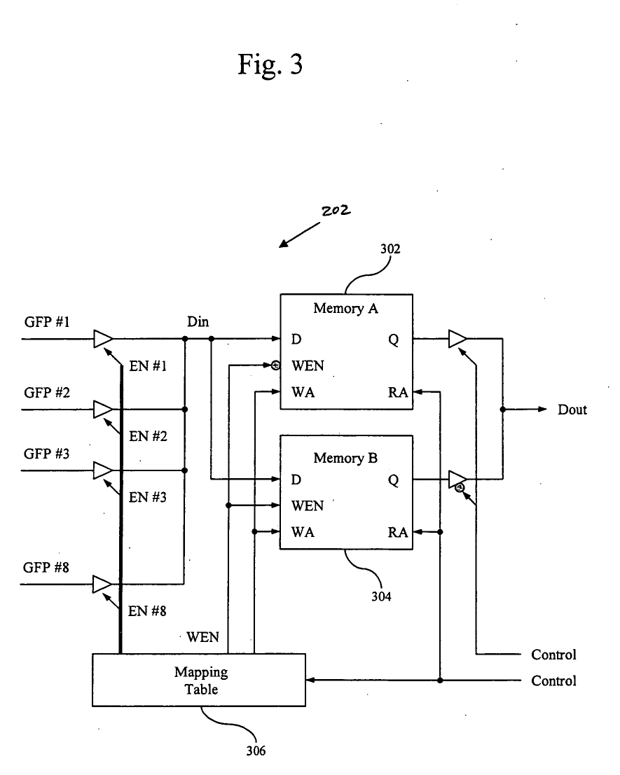

The GFP block signals are combined and stored in the memory 206 in their respective VC-11 channel number or write address. The memory 206 may be a dual port memory as described in more detail below. Each signal stored in the memory 206 corresponds to the predetermined time slot provided in the corresponding VC-11 position for the actual STM-1 frame. There is no limitation on the sequence of the time slot equivalent to each of the GFP blocks, therefore Random Write may be used to write the time slots in the memory 206. If one memory is used to perform the write and read functions, then write/read collision may occur if the write address and the read address are the same. To prevent the collision from occurring, the VCG mapper 202 may utilize more than one memory. For example, FIG. 3 shows a VCG mapper 202 including a first memory 302 and a second memory 304, and a mapping table 306. The first memory 302 may be used to write and the second memory 304 may be used to read so that write/read collision does not occur. The mapping table 306 may control the memory action illustrated in FIG. 3.

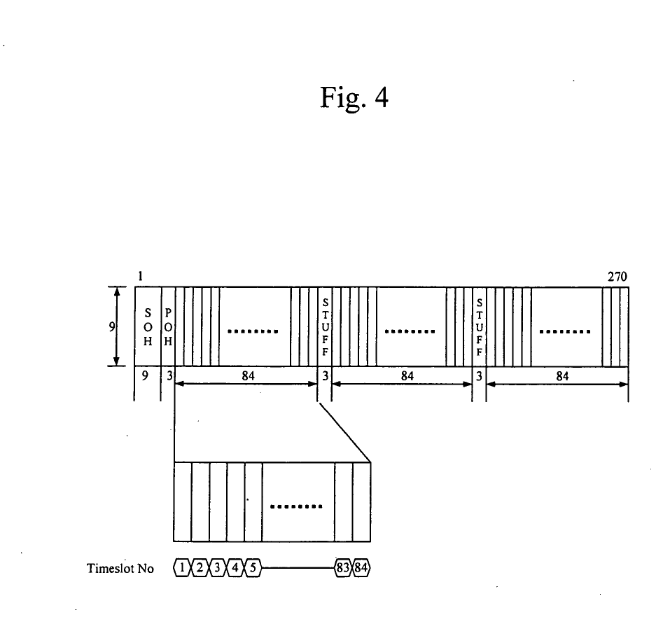

FIG. 4 shows STM-1 signal having one row of 270 bytes where the first 9 bytes is section overhead (SOH). During transmission of data, a fixed pointer is generally used so that if three VC-3 signals are used, then the next three bytes are path overhead (POH), and there are stuffing bytes in the middle with three bytes each. In this space, data is not multiplexed. The remaining 254 channels (270-9-3-3-3) can be divided into 84 channels, where 84 VC-11 signals may be multiplexed three times in a row (252/3=84). The same time slot number described in FIG. 4 can be obtained in this space using a counter. Each time slot number may match each VC-11 number and the value is established at 1 through 84.

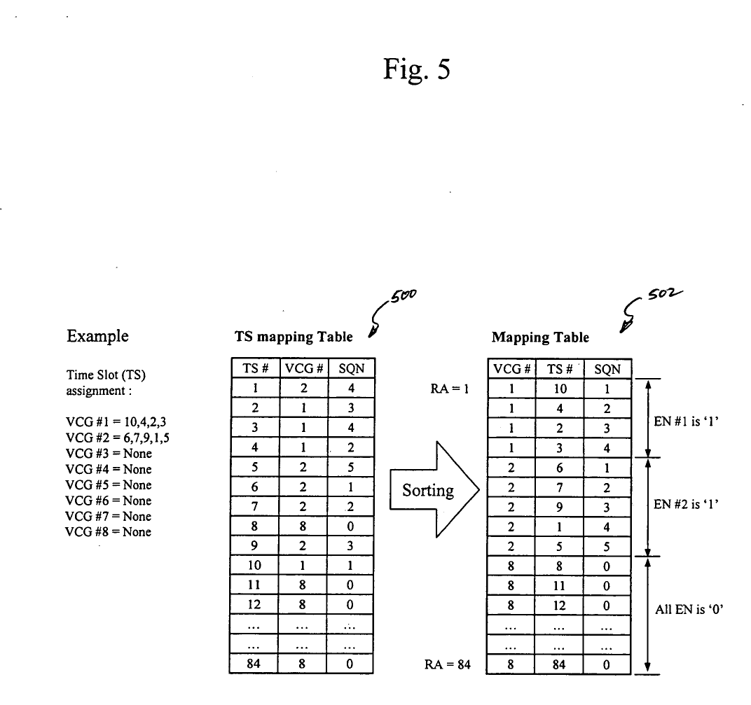

The mapping table in FIG. 5 uses time slot numbers as memory read address. For example, in FIG. 5, Time Slot (TS) assignment indicates VCG #1 through VCG #8 in order to distinguish each of the eight VCGs. In this example, four time slot numbers 10, 4, 2, and 3 are sequentially allocated to VCG #1, five time slot numbers 6, 7, 9, 1, and 5 are sequentially allocated to VCG #2, and when there is no signal—no time slots are allocated to the remaining VCG #3 through VCG #8 so that a value of 8 is given to the VCG #3 through VCG #8. Note that each time slot in VC-11 may provide 1.5M of bandwidth in STM-1 frame. In the above example, VCG #1 has 6.0M (4×1.5M) of bandwidth because VCG #1 is assigned with four time slots, and VCG #2 has 7.5M (5×1.5M) of bandwidth because VCG #2 is assigned with five time slots. By assigning an appropriate number of time slot(s) to each of the VCGs, the bandwidth provided to each of the VCGs may be adjusted based on the bandwidth need of the enterprise customer. LCAS may assign the time slots to each of the VCGs. In this example, the VCG #1 through VCG #8 may correspond to GFP #1 through GFP #8, respectively.

FIG. 5 shows a TS mapping table 500 based on the TS number assignments. The TS mapping table may be organized to correspond to the timeslot designation of 84 VC-11 signals within STM-1. The left column of TS mapping table represents the 1˜84 time slot numbers; the second column represents VCG number; and the third column represents the sequence (SQN) for that particular time slot number. For instance, in the TS mapping table, the TS#10 has VCG# of 1 and SQN of 1 because the time slot 10 was allocated to VCG #1 and the time slot 10 is the first sequence within VCG #1. The TS#4 has VCG# of 1 and SQN of 2 because the time slot 4 was allocated to VCG #1 and the time slot 4 is the second sequence within VCG #1. TS#7 has VCG# of 2 and SQN of 2 because the time slot 7 was allocated to VCG #2 and the time slot 7 is the second sequence within VCG #2. TS#1 has VCG# of 2 and SQN of 4 because the time slot 1 was allocated to VCG #2 and the time slot 1 is the fourth sequence within VCG #2. TS#8 has VCG# of 8 and SQN of 0 because there is no signal allocated to TS#8. The rest of the TS mapping table may be filled with the methodology described above. The TS mapping table may be then reorganized based on the VCG# as illustrated in the mapping table 502 in FIG. 5. The mapping table 502 may represent the mapping table 306 shown in FIG. 3.

The TS# in the mapping table 502 may represent the writing address signals for the dual-port RAM as discussed above. After the mapping table 502 is established, the mapping table 502 may be read sequentially from top to bottom, i.e., from RA=1 to RA=84. The TS#s from the mapping table 502 may be read sequentially to represent the write address of the dual-port RAM. For instance, sequentially reading the TS#s from RA=1 to RA=12 in the mapping table 502 would result 10, 4, 2, 3, 6, 7, 9, 1, 5, 8, 11, and 12. LCAS assigns the timeslots to the VCGs so that the order of the TS#s listed in the mapping table 502 is based on the order in which the particular TS# was assigned to one specific VCG# by LCAS. In subsequent assignments, however, LCAS may assign the same TS# to a different VCG# and in a different order within that VCG#. As such, the write address of the dual-port RAM may be random. The number of time slots in the STM-1 frame shown in FIG. 4 indicates that the read address in the dual port memory may occur sequentially from 1 to 84 where VC-11 is positioned in STM-1 frame. The data stored in the mapping table in accordance with the time slots may be read sequentially which provides the write address where GFP signals are written into the STM-1 frame.

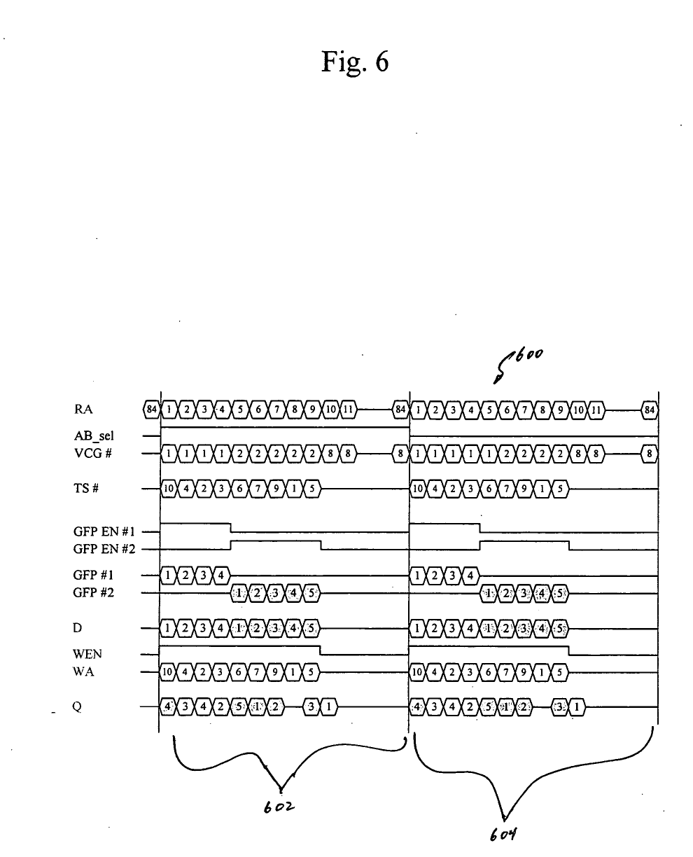

FIG. 6 shows a timing diagram 600 illustrating the reading of the data stored in the memory sequentially so that the data may be transposed into the STM-1 frame format. The timing diagram 600 shows a first time frame 602 corresponding to reading of the data stored in the memory 302, and a second timeframe 604 corresponding to reading of the data stored in the memory 304. In FIG. 6, RA is equivalent to the timeslot number described in reference to FIG. 4. AB_SEL signal is a signal used to avoid write/read collision. For instance, when the first time frame 602 shows that the AB_sel signal is ON or “1,” the second time frame 604 is OFF or “0” to avoid write/read collision between the two memories 302 and 304. VCG# and TS# in the timing diagram 600 are the result of sequentially reading the corresponding values from RA=1 to RA=84 in the mapping table 502.

Referring back to FIG. 3, the GFP #1 through GFP #8 may sequentially provide the data sequentially to a node D of the memory 302 and then to the memory 304. Each of the GFPs may be turned ON through its corresponding enabler EN that allows the data to be provided to the node D of the memory 302 and then to the memory 304. For example, in the mapping table 502, the enabler EN #1 may be ON or “1” from RA=1 to RA=4 corresponding to VCG #1, then the enabler EN #2 may be ON or “1” from RA=5 to RA=9 corresponding to VCG #2. For instance, FIG. 6 shows GFP EN #1 is ON or “1” for a predetermined period of time to allow GFP #1 to provide SQN from 1 to 4, then GFP EN #2 is On or “1” for a predetermined period of time to allow GFP #2 to provide SQN from 1 to 5. D represents the combined data of GFP #1 and #2. WEN signal controls the memory write time to the memory. In this example, WEN signal is a combination of GFP EN #1 and #2 signals. WA signal represents the write address in the memory. In this example, WA corresponds to TS# in the mapping table 502 from RA=1 to RA=84. Q is the output data. The data from each of the GFP is written into the memory based on the TS# (equal to WA) provided in FIG. 6 or from the mapping table 500. The last output “Q” in FIG. 6 can be obtained by reading the memory based on the RA in FIG. 6. In FIG. 6, “Q” is multiplexed data output in the timeslot location in STM-1 frame designated by 2 VCG.

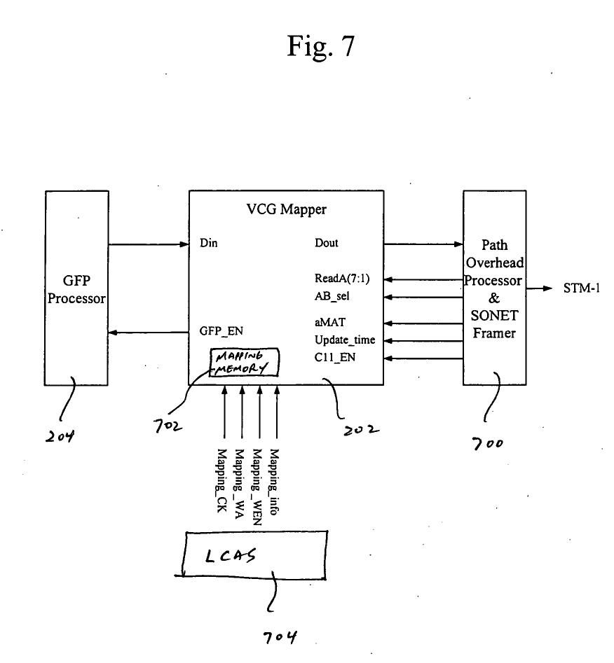

FIG. 7 shows VCG mapper 202 configured to interface data between GFP processor 204 and Path Overhead Processor 700. The VCG mapper 202 receives and handles the necessary timing signal from SONET framer. The VCG mapper 202 may also include a mapping table 702 configured to receive mapping table information from a LCAS block 704. The mapping table information is received from the LCAS block when the LCAS function is applied and receives the value designated by the operator from the outside processor when the LCAS function is not used. For the GFP block, it provides an EN signal for the GFP block and receives data.

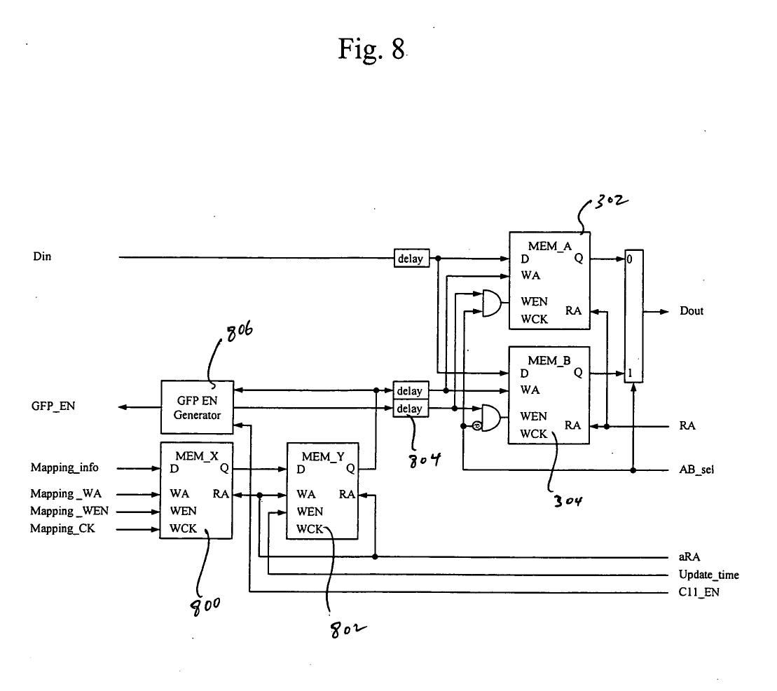

FIG. 8 is a detail circuit diagram of the VCG mapper 202 shown in FIG. 7. In this example, a first mapping memory 800 and a second mapping memory 802 may be used to store the mapping table information to provide two layers of memories so that mapping information may be amended or changed in a more reliable way. In addition, one or more delays 804 may be provided between the two mapping memories 800 and 802 and the memories 302 and 304. The delays 804 may be used to compensate for the time it takes to update the SQN in the two mapping memories 800 and 802 so that the interface between VCG 302 and STM-1 frame may be synchronized. For example, if an enterprise customer increases the bandwidth requirement from 4.5 M to 6.0 M after the timeslots have been already assigned based on the 4.5 M requirement, it may take a predetermined amount of time to update the mapping memories to the new bandwidth requirement. When the mapping information is updated or revised, the updated mapping information may be first provided to the first mapping memory 800, and at a later time the updated mapping information stored in the first mapping memory 800 may be provided to the second mapping memory 802. This allows the second mapping memory 802 to backup the first mapping memory 800 so that the updated mapping information is not lost. The new mapping information provided to the first mapping memory 800 may be the same as mapping table information illustrated in FIG. 5. The updated mapping information is then read by the GFP EN generator 806 to provide the GFP EN # signal to the corresponding GFP blocks 204. However, there may be a delay in updating the second mapping memory 802 and providing the GFP EN # signal. To compensate for the delay, the delay 804 may be used to provide the updated mapping information to the first and second memories 302 and 304 at a predetermined time.

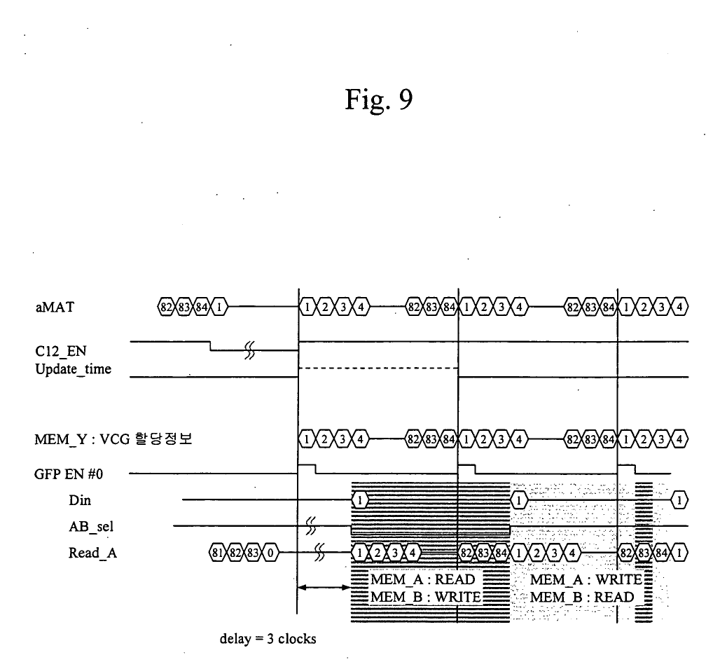

FIG. 9 shows the timing diagram of the VCG mapper 202 with a delay of three clocks. As discussed above in reference to FIG. 8, the delay in updating the mapping information may be too long of a period such that the delay 804 may be incorporated to synchronize with the VCG 202. In FIG. 9, the update_time may be ON or “1,” however, it may take about three clock time periods to update the new mapping information. Under such circumstances, the delay 804 may wait for about three clocks and reinitiate the interface with the first and second memories 302 and 304. In this example, the read addresses which read the mapping table information and data containing the first and second memories 300 and 302 may have the applicable delay. The output signals from the first and second memories 300 and 302 may be selected and outputted according to the AB-SEL signal which prevents write/read collision.

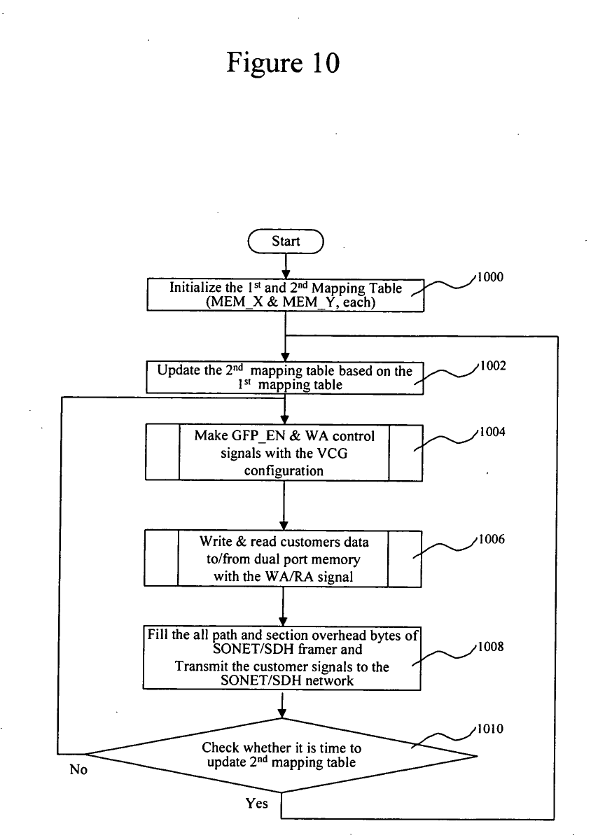

FIG. 10 is a flow chart illustrating the operation of the VCG mapper 202. In block 1000, the interface system 200 initializes the first and second memories 800 and 802. Note that the first mapping table may be written by LCAS. In block 1002, the second mapping table 802 may be updated by VCG Mapper but first mapping table 800 may be updated by LCAS. In other words, the first and second mapping memories 800 and 802 may be used to separate the timing of internal processing timing and Mapping_info write timing. Mapping_info write timing (Mapping_info, Mapping_WA, Mapping_WEN, Mapping_CK) is provided by LCAS or operator in case of non-LCAS system. Because of processing delay in LCAS, there may be some timing issues between LCAS and VCG mapper. If the process timing of LCAS and VCG mapper do not match, then some errors may occur. To prevent the errors and not restrict the LCAS processing timing, two-stage memory is used. Simply, LCAS process the mapping information and first writes the result to the first memory 800, then the information is transfer to the second memory 802 according the internal timing of VCG mapper. The two-stage (or layer) memory provides more loose timing relationship between LCAS and VCG mapper.

In block 1004, based on the mapping information, as illustrated in table 502, GFP_EN and WA control signals are determined as illustrated in FIG. 6. In block 1006, based on the WA and RA signals, the customer data are written and read to/from the dual port memory 302 and 304, as illustrated in FIG. 6. In block 1008, path and section overhead bytes of SONET/SDH framer are filled, as illustrated in FIG. 4, and the customer signals are transmitted to the SONET/SDH network. In decision block 1010, the interface system 200 update the mapping table 502 based on the revised configuration.

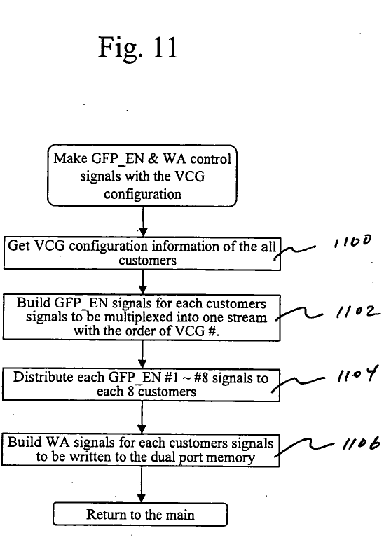

FIG. 11 shows a flow chart further illustrating the block 1004 directed to generating GFP_EN and WA control signals with the VCG configuration. In block 1100, VCG configuration information is gathered for all of the customers. For example, in FIG. 5, VCG #1 was assigned time slots 10, 4, 2, and 3; VCG #2 was assigned time slots 6, 7, 9, 1, and 5; and remaining VCG #3 through VCG #8 were assigned 8 because no time slots were allocated. In block 1102, GFP_EN signals are generated for each of the customers so that the signals can be multiplexed into one steam of data corresponding to the VCG#s, as illustrated in FIG. 6. In block 1104, each of the GFP_EN numbers are distributed to the corresponding customer. For example, in FIG. 6, GFP_EN #1 is distributed to VCG #1 and GFP_EN #2 is distributed to VCG #2. In block 1106, WA signals for each of the customers are generated to be written to the dual port memory, as illustrated in FIG. 6.

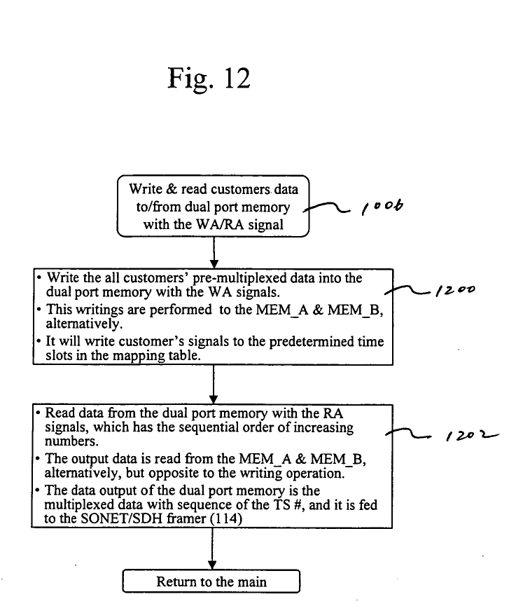

FIG. 12 shows a flow chart further illustrating the block 1006 discussed in the flow chart shown in FIG. 10. In block 1200, customers' pre-multiplexed data are written alternatively into the dual port memory MEM_A 302 and MEM_B 304. In other words, customers' signals are written into the predetermined time slots in the mapping table 502, as illustrated in FIG. 5. In block 1202, the data in the dual port memory MEM_A 302 and MEM_B 304 may be read sequentially from the first RA to the last RA. For example, in the mapping table 502, the TS#s are read sequentially from RA=1 to RA=8. The TS#s may be read from the dual port memory MEM_A 302 and MEM_B 304 alternatively, but opposite of the writing operation. The data output from the dual port memory MEM_A 302 and MEM_B 304 are multiplexed data which are fed to the SONET/SDH framer 114. As such, by utilizing a mapping table and a dual-port memory, the interface system is able to allow Ethernet to send data through SONET without the need of a switching block used by others. This eliminates the problems associated with the switching block and minimizes the sizes of the overall circuit.

While various embodiments of the invention have been described, it will be apparent to those of ordinary skill in the art that many more embodiments and implementations are possible within the scope of this invention. For instance, the specification attached to this patent application as Exhibit A is incorporated into this patent application. Accordingly, the invention is not to be restricted except in light of the attached claims and their equivalents.

What is claimed is:

1. A virtual concatenation group (VCG) mapper adapted to interface a customer's bandwidth requirement to bandwidth provided by a SONET/SDH network, the VCG mapper comprising:
a writing port adapted to receive a continuous signal from a customer;
a first memory adapted to assign the continuous signal from the customer to predetermined time slots corresponding to a SONET/SDH frame; and
a reading port adapted to provide the continuous signal in the predetermined time slots to a SONET/SDH framer to transmit the continuous signal through the SONET/SDH network.

2. The VCG mapper according to claim 1, where the VCG mapper is at least one of the following virtual containers VC-11, VC-12, VC-3, and VC-4.

3. The VCG mapper according to claim 1, where the SONET/SDH network is STM-1 (OC-3), STM-4(OC-12) or STM-16(OC-48).

4. The VCG mapper according to claim 1, where the first memory is a dual port memory.

5. The VCG mapper according to claim 1, further including a second memory adapted to simultaneously assign the continuous signal from the customer to the predetermined time slots.

6. The VCG mapper according to claim 5, where the second memory assigns the continuous signal simultaneously to the predetermined time slots to substantially prevent read and write address collision when the address of the read and write are the same.

7. The VCG mapper according to claim 6, where the first memory has a first write enable (WEN) and the second memory has a second WEN, where the second WEN is on when the first WEN is off.

8. The VCG mapper according to claim 5, further including a first mapping table configured to provide address information that is used to write data onto the first and second memories.

9. The VCG mapper according to claim 8, further including second mapping table to temporarily store a revised VCG configuration to update the write data onto the first memory.

10. An interface system capable of transmitting non-continuous data over a SONET/SDH network, the interface system including:
a GFP processor capable of transforming incoming packet data into continuous signal;
a virtual concatenation group (VCG) mapper configured to map the continuous signal to transmit the continuous signal over the SONET/SDH network; and
a SONET/SDH framer configured to transmit the continuous signals through the SONET/SDH network.

11. The interface system according to claim 10, where the VCG mapper includes:
a writing port adapted to receive the continuous signal;
a first memory adapted to assign the continuous signal to predetermined time slots corresponding to a SONET/SDH frame; and
a reading port adapted to provide the continuous signal in the predetermined time slots to the SONET/SDH framer to transmit the continuous signal through the SONET/SDH network.

12. The interface system according to claim 10, where the first memory is a dual port memory.

13. The interface system according to claim 10, further including a second memory adapted to simultaneously assign the continuous signal from the customer to the predetermined time slots.

14. The interface system according to claim 13, where the second memory assigns the continuous signal simultaneously to the predetermined time slots to substantially prevent read and write address collision when the address of the read and write are the same.

15. The interface system according to claim 14, where the first memory has a first write enable (WEN) and the second memory has a second WEN, where the second WEN is on when the first WEN is off.

16. The interface system according to claim 13, further including a first mapping table configured to provide address information that is used to write data onto the first and second memories.

17. The interface system according to claim 16, further including second mapping table to temporarily store a revised VCG configuration to update the write data onto the first memory.

18. A method of interfacing a customer's bandwidth requirement with bandwidth provided by SONET/SDH network, the method comprising:
assigning a continuous signal from the customer to predetermined time slots in a first mapping table;
outputting the continuous signal in the predetermined time slots from the second mapping table to a SONET/SDH framer;
transmitting the customer signal through the SONET/SDH network; and
if there is a revised configuration of the mapping table, then writing revised configuration information to a second mapping table.

19. The method according to claim 18, including updating the second mapping table based on the first mapping table.

20. The method according to claim 19, including delaying the updating of the second mapping table based on the first mapping table to compensate for the time it takes to update the two mapping tables.

21. A virtual concatenation group (VCG) mapper adapted to interface a customer's bandwidth requirement to bandwidth provided by a SONET/SDH network, the VCG mapper comprising:
means for receiving a continuous signal from a customer;
means for storing the continuous signal from the customer to predetermined time slots corresponding to a SONET/SDH frame; and
means for transmitting the continuous signal through the SONET/SDH network.

22. The VCG mapper according to claim 21, where the means for receiving the continuous signal is a GFP processor.

23. The VCG mapper according to claim 21, where the means for storing the continuous signal to the predetermined time slots is a memory.

24. The VCG mapper according to claim 23, where the memory is a dual port memory.

25. An interface system capable of transmitting non-continuous data over a SONET/SDH network, the interface system including:
means for transforming incoming packet data into continuous signal;
means for mapping the continuous signal to transmit the continuous signal over the SONET/SDH network; and
means for transmitting the continuous signals through the SONET/SDH network.

26. The interface system according to claim 25, where the means for mapping is a VCG mapper, the VCG mapper including:
a writing port adapted to receive the continuous signal;
a first memory adapted to assign the continuous signal to predetermined time slots corresponding to a SONET/SDH frame; and
a reading port adapted to provide the continuous signal in the predetermined time slots to the SONET/SDH framer to transmit the continuous signal through the SONET/SDH network.
